(19) United States
(12) Patent Application Publication
(10) Pub. No.: US 2026/0006671 A1
(43) Pub. Date: Jan. 1, 2026

(54) COMMUNICATION METHOD AND APPARATUS, ELECTRONIC DEVICE AND STORAGE MEDIUM

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 18/881,075

(22) PCT Filed: Jul. 5, 2022
(86) PCT No.: PCT/CN2022/103961

§ 371 Date: Jan. 3, 2025

(51) Int. Cl. H04W 76/19; H04W 72/29

(52) U.S. Cl. CPC H04W 76/19; H04W 72/29

(57) ABSTRACT

A communication method and apparatus, an electronic device, and a storage medium. The communication method is applied to a non-access point multi-link device (Non-AP MLD). The method comprises: monitoring that a beacon frame sent by an access point multi-link device (AP MLD) comprises an added affiliated AP, and obtaining parameter information of the added affiliated AP; and carrying the parameter information in a target radio frame, and sending the target radio frame, wherein the target radio frame instructs to re-establish a connection with the AP MLD. Provided is a method for associating a Non-AP MLD to an added affiliated AP.

### TECHNICAL FIELD

Embodiments of the present disclosure relate to the mobile communication technical field. Specifically, the embodiments of the present disclosure relate to a communication method and apparatus, an electronic device, and a storage medium.

### BACKGROUND

With the rapid developments of mobile communication technologies, Wireless Fidelity (Wi-Fi) technology has made great progress in transmission rate and throughput. At present, the research content of Wi-Fi technology includes, for example, 320 Mhz bandwidth transmission, aggregation and coordination of multiple frequency bands, etc. Its main application scenarios include video transmission, Augmented Reality (AR), Virtual Reality (VR), etc.

Specifically, the aggregation and coordination of multiple frequency bands means that devices can communicate with each other at 2.4 GHz, 5.8 GHz, 6 GHZ and other frequency bands at the same time. For the scenario where devices communicate with each other at multiple frequency bands at the same time, a new Media Access Control (MAC) mechanism needs to be defined to perform management. In addition, the aggregation and coordination of multiple frequency bands is expected to support low-latency transmission.

At present, the maximum bandwidth supported by the aggregation and coordination technology of multiple frequency bands is 320 MHz (160 MHz+160 MHz). In addition, 240 MHz (160 MHz+80 MHz) and other bandwidths supported by existing standards may also be supported.

In the Wi-Fi technology currently being studied, an Access Point Multi-Link Device (AP MLD) that supports multiple links can add a new affiliated AP at any time. After adding a new affiliated AP, a station Multi-Link Device (Non-AP MLD) that establishes a multi-link communication with the AP MLD needs to be associated with the newly added affiliated AP. Therefore, it is necessary to provide an implementation method for the Non-AP MLD to be associated with the newly added affiliated AP.

### SUMMARY

Embodiments of the present disclosure provide a communication method and apparatus, an electronic device, and a storage medium to provide an implementation method for associating a Non-AP MLD with a newly added affiliated AP.

On the one hand, an embodiment of the present disclosure provides a communication method. The method is applied to a station multi-link device (Non-AP MLD). The method includes:
detecting that a beacon frame sent by an Access Point Multi-Link Device (AP MLD) includes a newly added affiliated AP, and obtaining parameter information of the newly added affiliated AP; and
carrying the parameter information in a target wireless frame, and sending the target wireless frame, wherein the target wireless frame indicates re-establishing a link with the AP MLD.

On the other hand, an embodiment of the present disclosure further provides an electronic device. The electronic device is a station multi-link device (Non-AP MLD). The electronic device includes:
an obtaining module configured to detect that a beacon frame sent by an Access Point Multi-Link Device (AP MLD) includes a newly added affiliated AP, and obtain parameter information of the newly added affiliated AP; and
a sending module configured to carry the parameter information in a target wireless frame and send the target wireless frame, wherein the target wireless frame indicates re-establishing a link with the AP MLD.

On the other hand, an embodiment of the present disclosure further provides a communication apparatus. The communication apparatus is applied to a station multi-link device (Non-AP MLD). The apparatus includes:
an information obtaining module configured to detect that a beacon frame sent by an Access Point Multi-Link Device (AP MLD) includes a newly added affiliated AP, and obtain parameter information of the newly added affiliated AP; and
a wireless frame sending module configured to carry the parameter information in a target wireless frame and send the target wireless frame, wherein the target wireless frame indicates re-establishing a link with the AP MLD.

An embodiment of the present disclosure further provides an electronic device, including a memory, a processor, and a computer program stored in the memory and runnable on the processor. When the processor executes the program, one or more methods described in the embodiments of the present disclosure are implemented.

An embodiment of the present disclosure further provides a computer-readable storage medium, on which a computer program is stored. When the computer program is executed by a processor, one or more of the methods described in the embodiments of the present disclosure are implemented.

In the embodiments of the present disclosure, it is detected by a Non-AP MLD that a beacon frame sent by an AP MLD includes a newly added affiliated AP, the Non-AP MLD obtains parameter information of the newly added affiliated AP, carries the parameter information in a target wireless frame, and sends the target wireless frame. The target wireless frame indicates re-establishing a link with the AP MLD. In this way, after the link is re-established, the Non-AP MLD is associated with the newly added affiliated AP, and communicates with the newly added affiliated AP, thus improving the regional throughput.

Additional aspects and advantages of the embodiments of the present disclosure will be partially given in the description below, which will become apparent from the description below, or will be learned through the practice of the present disclosure.

### BRIEF DESCRIPTION OF THE DRAWINGS

In order to more clearly illustrate the technical solutions of the embodiments of the present disclosure, the drawings required for the description of the embodiments of the present disclosure will be briefly introduced below. Obviously, the drawings in the following description are only some embodiments of the present disclosure. For those of ordinary skill in this art, other drawings can be obtained based on these drawings without creative work.

FIG. 1 is a first flowchart of a communication method according to an embodiment of the present disclosure;

FIG. 2 is a second flowchart of a communication method according to an embodiment of the present disclosure;

FIG. 3 is a third flowchart of a communication method according to an embodiment of the present disclosure;

FIG. 4 is a fourth flowchart of a communication method according to an embodiment of the present disclosure;

FIG. 5 is a first schematic diagram of a structure of an electronic device according to an embodiment of the present disclosure;

FIG. 6 is a second schematic diagram of a structure of an electronic device according to embodiment of the present disclosure.

### DETAILED DESCRIPTION

In the embodiments of the present disclosure, the term “and/or” describes an association relationship of associated objects, indicating that three relationships may exist. For example, A and/or B may represent three situations: A exists alone, A and B exist at the same time, and B exists alone. The character “/” generally indicates that the associated objects before and after “/” are in an “or” relationship.

The term “multiple/plurality of” in the embodiments of the present disclosure refers to two or more than two, and other quantifiers are similar.

Example embodiments will be described in detail herein, examples of which are shown in the accompanying drawings. In the drawings referred to in the following descriptions, the same numbers in different drawings represent the same or similar elements, unless otherwise indicated. The implementations described in the following example embodiments do not represent all embodiments consistent with the present disclosure. Instead, they are merely examples of apparatuses and methods consistent with some aspects of the present disclosure as detailed in the appended claims.

The terms used in the present disclosure are for the purpose of describing specific embodiments only and are not intended to limit the present disclosure. The singular forms “a/an”, “said” and “the” used in the present disclosure and the appended claims are also intended to include a plural form, unless the context clearly indicates otherwise. It should also be understood that the term “and/or” used herein refers to and includes any or all possible combinations of one or more associated listed items.

It should be understood that although the terms “first”, “second”, “third”, etc. may be used in the present disclosure to describe various types of information, such information should not be limited to these terms. These terms are only used to distinguish the same type of information from each other. For example, without departing from the scope of the present disclosure, first information may also be referred to as second information, and similarly, the second information may also be referred to as the first information. Depending on the context, the word “if” as used herein may be interpreted as “when” or “in a case where . . . ” or “in response to determining . . . ”.

The technical solutions in the embodiments of the present disclosure will be described below clearly and completely in conjunction with the drawings in the embodiments of the present disclosure. Obviously, the described embodiments are only part of the embodiments of the present disclosure, not all of the embodiments. Based on the embodiments in the present disclosure, all other embodiments obtained by those of ordinary skill in this art without creative work also fall within the scope of protection of the present disclosure.

The embodiments of the present disclosure provide a communication method and apparatus, an electronic device, and a storage medium to provide an implementation method for associating a Non-AP MLD with a newly added affiliated AP.

The method and the electronic device and the apparatus are based on the same application concept. Since the principles of solving problem(s) by the method and the electronic device and the apparatus are similar, the implementations of the electronic device, the apparatus and the method can refer to each other, and the repeated descriptions will be omitted.

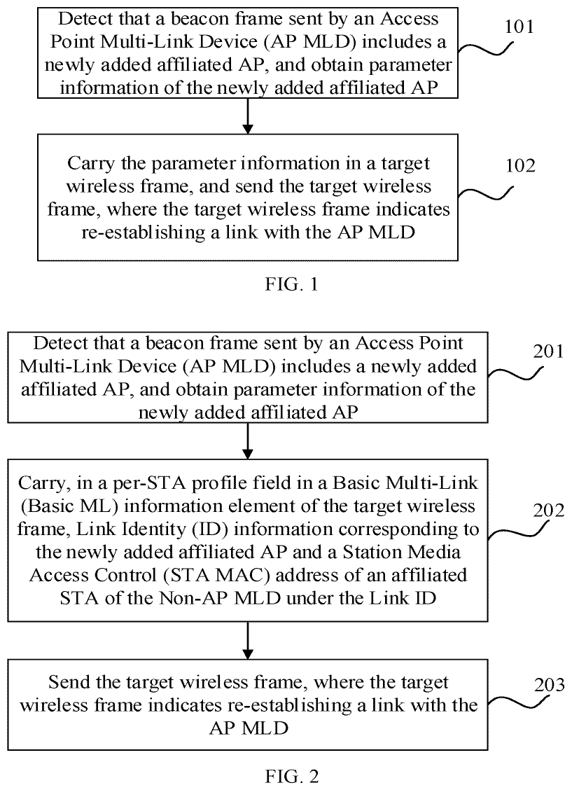

As shown in FIG. 1, an embodiment of the present disclosure provides a communication method. Optionally, the method may be applied to a station multi-link device (Non-AP MLD).

The method may include the following steps:

In step 101, it is detected that a beacon frame sent by an Access Point Multi-Link Device (AP MLD) includes a newly added affiliated AP, and parameter information of the newly added affiliated AP is obtained.

Normally, an Access Point Multi-Link Device (AP MLD) can add a new affiliated AP (hereinafter referred to as newly added affiliated AP) at any time. The AP MLD indicates, through a Reduced Neighbor Report element and a Basic Multi-Link element of the beacon frame, that the AP MLD adds a new affiliated AP.

It is detected by the Non-AP MLD that the beacon frame sent by the Access Point Multi-Link Device (AP MLD) includes the newly added affiliated AP, and the Non-AP MLD obtains parameter information of the newly added affiliated AP, such as Link Identity (Link ID) information corresponding to the newly added affiliated AP.

In step 102, the parameter information is carried in a target wireless frame and the target wireless frame is sent. The target wireless frame indicates re-establishing a link with the AP MLD.

The target wireless frame is, for example, a reassociation request frame (Reassociation Request). The Non-AP MLD carries the parameter information in the target wireless frame and sends the target wireless frame to request to reestablish a link with the AP MLD and communicate with the newly added affiliated AP. It can be understood that in the embodiment of the present disclosure, association refers to establishing a communication link.

In the embodiment of the present disclosure, it is detected by the Non-AP MLD that the beacon frame sent by the AP MLD includes a newly added affiliated AP, the Non-AP MLD obtains parameter information of the newly added affiliated AP, carries the parameter information in a target wireless frame, and sends the target wireless frame. The target wireless frame indicates re-establishing a link with the AP MLD. In this way, after the link is re-established, the Non-AP MLD is associated with the newly added affiliated AP, and communicates with the newly added affiliated AP, thus improving the regional throughput.

An embodiment of the present disclosure further provides a communication method. Optionally, the method may be applied to a station multi-link device (Non-AP MLD). The method may include the following steps:
detecting that a beacon frame sent by an Access Point Multi-Link Device (AP MLD) includes a newly added affiliated AP, and obtaining parameter information of the newly added affiliated AP; and
carrying the parameter information in a target wireless frame, and sending the target wireless frame, where the target wireless frame indicates re-establishing a link with the AP MLD, and the target wireless frame includes a reassociation request frame (Reassociation Request) or a multi-link re-establishment request frame; where in a case where the AP MLD adds a new affiliated AP, the Non-AP MLD carries the parameter information in the reassociation request frame, the re-establishment request frame or the multi-link re-establishment request frame to achieve association with the newly added affiliated AP.

Referring to FIG. 2, an embodiment of the present disclosure further provides a communication method. Optionally, the method may be applied to a station multi-link device (Non-AP MLD). The method may include the following steps:

In step 201, it is detected that a beacon frame sent by an Access Point Multi-Link Device (AP MLD) includes a newly added affiliated AP, and parameter information of the newly added affiliated AP is obtained.

It is detected by the Non-AP MLD that the beacon frame sent by the an Access Point Multi-Link Device (AP MLD) includes the newly added affiliated AP, and the Non-AP MLD obtains parameter information of the newly added affiliated AP, such as Link Identity (Link ID) information corresponding to the newly added affiliated AP.

In step 202, Link Identity (ID) information corresponding to the newly added affiliated AP and a Station Media Access Control (STA MAC) address of an affiliated STA of the Non-AP MLD under the Link ID are carried in a per-STA profile field in a Basic Multi-Link (Basic ML) information element of the target wireless frame.

Normally, the Basic Multi-Link (Basic ML) element is used to carry the information of a Multi-Link Device (MLD) and its affiliated stations (STA) during the multi-link discovery procedure. The Non-AP MLD carries the Link ID information corresponding to the newly added affiliated AP and the STA MAC address of an affiliated STA in a per-STA profile field in the Basic ML information element to indicate the Link ID of the newly added affiliated AP and the STA MAC address information of the affiliated STA, where the MAC address refers to a Media Access Control (MAC) address.

In step 203, the target wireless frame is sent, where the target wireless frame indicates re-establishing a link with the AP MLD.

In an optional embodiment, the method further includes:
carrying a MLD MAC address of the Non-AP MLD in a common information (Common Info) field of the Basic Multi-Link (Basic ML) information element of the target wireless frame to indicate the MAC address of the MLD to which the STA that transmits the Basic ML belongs.

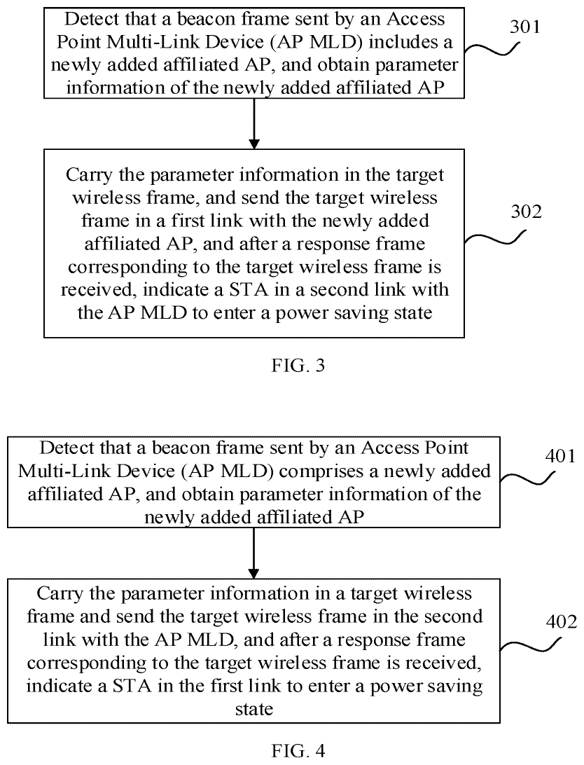

Referring to FIG. 3, an embodiment of the present disclosure further provides a communication method. Optionally, the method may be applied to a station multi-link device (Non-AP MLD). The method may include the following steps:

In step 301, it is detected that a beacon frame sent by an Access Point Multi-Link Device (AP MLD) includes a newly added affiliated AP, and parameter information of the newly added affiliated AP is obtained.

It is detected by the Non-AP MLD that the beacon frame sent by the Access Point Multi-Link Device (AP MLD) includes the newly added affiliated AP, and the Non-AP MLD obtains parameter information of the newly added affiliated AP, such as Link Identity (Link ID) information corresponding to the newly added affiliated AP.

In step 302, the parameter information is carried in a target wireless frame, the target wireless frame is sent in a first link with the newly added affiliated AP, and after a response frame corresponding to the target wireless frame is received, a STA in a second link with the AP MLD is indicated to enter a power saving state.

The first link is a link with the newly added affiliated AP; the target wireless frame can be sent under the link of the newly added affiliated AP, and after receiving the response frame corresponding to the target wireless frame, such as a reassociation response frame for the reassociation request frame, a STA under other link(s) is indicated to immediately enter a Power Save (PS) state. The second link is link(s) of the AP MLD except the first link.

Referring to FIG. 4, an embodiment of the present disclosure further provides a communication method. Optionally, the method may be applied to a station multi-link device (Non-AP MLD). The method may include the following steps:

In step 401, it is detected that a beacon frame sent by an Access Point Multi-Link Device (AP MLD) includes a newly added affiliated AP, and parameter information of the newly added affiliated AP is obtained.

It is detected by the Non-AP MLD that the beacon frame sent by the Access Point Multi-Link Device (AP MLD) includes the newly added affiliated AP, and the Non-AP MLD obtains parameter information of the newly added affiliated AP, such as Link Identity (Link ID) information corresponding to the newly added affiliated AP.

In step 402, the parameter information is carried in a target wireless frame, and the target wireless frame is sent in a second link with the AP MLD, and after a response frame corresponding to the target wireless frame is received, a STA in the first link is indicated to enter a power saving state.

The first link is a link of the newly added affiliated AP, and the second link is link(s) of the AP MLD except the first link. The Non-AP MLD may send the target wireless frame under any one of the second link(s), and after a response frame corresponding to the target wireless frame is received, such as a reassociation response frame for a reassociation request frame, a STA under the first link is indicated to immediately enter the power saving state.

An embodiment of the present disclosure further provides a communication method. Optionally, the method may be applied to a station multi-link device (Non-AP MLD). The method may include the following steps:
detecting that a beacon frame sent by an Access Point Multi-Link Device (AP MLD) includes a newly added affiliated AP, and obtaining parameter information of the newly added affiliated AP; and
carrying the parameter information in a target wireless frame, and sending the target wireless frame, where the target wireless frame indicates re-establishing a link with the AP MLD;
wherein a Traffic Identifier-to-Link mapping (TID-to-Link mapping) information element is carried in the target wireless frame, wherein the TID-to-Link mapping information element includes first TID-to-Link mapping information of the Non-AP MLD and the AP MLD as well as second TID-to-Link mapping information of the Non-AP MLD and the newly added affiliated AP.

The first TID-to-Link mapping information is the TID-to-Link mapping information between the Non-AP MLD and the AP MLD before the affiliated AP is newly added, and the second TID-to-Link mapping information is the TID-to-Link mapping information between the Non-AP MLD and the newly added affiliated AP. For the newly added affiliated AP, the Non-AP MLD carries the first TID-to-Link mapping information and the second TID-to-Link mapping information in the target wireless frame, to request the AP MLD to perform a corresponding TID-to-Link mapping operation, so that the TID-to-Link mapping mechanism is implemented and the spectrum utilization is improved.

In the embodiments of the present disclosure, it is detected by the Non-AP MLD that the beacon frame sent by the AP MLD includes a newly added affiliated AP, the Non-AP MLD obtains parameter information of the newly added affiliated AP, carries the parameter information in a target wireless frame, and sends the target wireless frame. The target wireless frame indicates re-establishing a link with the AP MLD. In this way, after the link is re-established, the Non-AP MLD is associated with the newly added affiliated AP, and communicates with the newly added affiliated AP, thus improving the regional throughput.

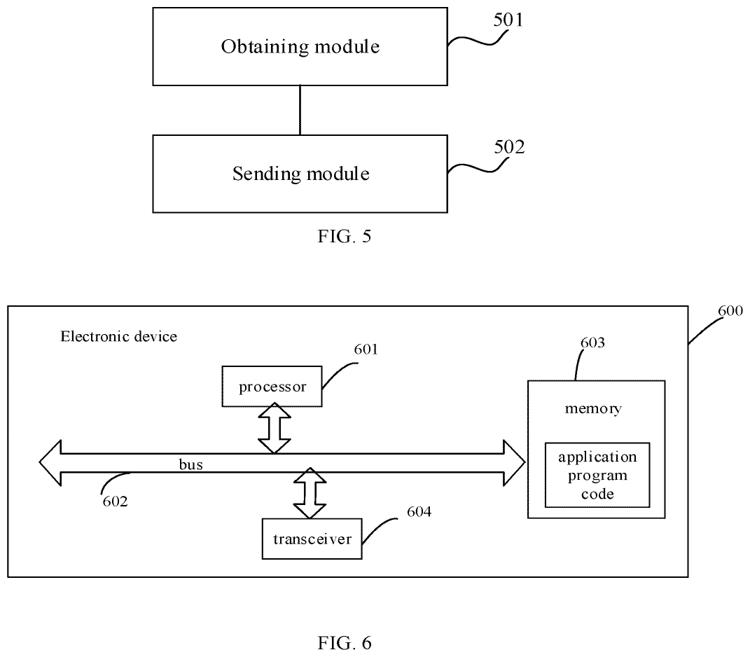

Referring to FIG. 5, based on the same principle as the communication methods provided in the embodiments of the present disclosure, an embodiment of the present disclosure further provides an electronic device. The electronic device is a station multi-link device (Non-AP MLD). The electronic device includes an obtaining module 501 and a sending module 502.

The obtaining module 501 is configured to detect that a beacon frame sent by an Access Point Multi-Link Device (AP MLD) includes a newly added affiliated AP, and obtain parameter information of the newly added affiliated AP.

Normally, an Access Point Multi-Link Device (AP MLD) can add a new affiliated AP (hereinafter referred to as newly added affiliated AP) at any time. The AP MLD indicates, through a Reduced Neighbor Report element or a Basic Multi-Link element of the beacon frame, that the AP MLD adds a new affiliated AP.

It is detected by the Non-AP MLD that the beacon frame sent by the Access Point Multi-Link Device (AP MLD) includes the newly added affiliated AP, and the Non-AP MLD obtains parameter information of the newly added affiliated AP, such as Link Identity (Link ID) information corresponding to the newly added affiliated AP.

The sending module 502 is configured to carry the parameter information in a target radio frame and send the target radio frame, wherein the target radio frame indicates re-establishing a link with the AP MLD.

The target wireless frame is, for example, a reassociation request frame (Reassociation Request). The Non-AP MLD carries the parameter information in the target wireless frame and sends the target wireless frame to request to reestablish a link with the AP MLD. Thus, after the link is reestablished, the Non-AP MLD is associated with the newly added subsidiary AP and communicates with the newly added subsidiary AP, thus improving the regional throughput. It can be understood that in the embodiments of the present disclosure, association refers to establishing a communication link.

Optionally, in an embodiment of the present disclosure, the target wireless frame includes a reassociation request frame or a re-establishment request frame.

Optionally, in the embodiment of the present disclosure, the sending module 502 includes:
a first processing submodule configured to carry, in a per-STA profile field in a Basic Multi-Link (Basic ML) information element of the target wireless frame, Link Identity (ID) information corresponding to the newly added affiliated AP and a Station Media Access Control (STA MAC) address of an affiliated STA of the Non-AP MLD under the Link ID.

Optionally, in the embodiment of the present disclosure, the sending module 502 is further configured to:
carry a MLD MAC address of the Non-AP MLD in a common information (Common Info) field of a Basic ML information element of the target wireless frame.

Optionally, in an embodiment of the present disclosure, the sending module 502 includes:
a second processing submodule configured to send the target wireless frame in a first link with the newly added affiliated AP, and after a response frame corresponding to the target wireless frame is received, indicate a STA in a second link with the AP MLD to enter a power saving state; or
a third processing submodule configured to send the target wireless frame in the second link with the AP MLD, and after a response frame corresponding to the target wireless frame is received, indicate a STA in the first link to enter a power saving state.

Optionally, in an embodiment of the present disclosure, the electronic device further includes:
a mapping processing module configured to carry a Traffic Identifier-to-Link mapping (TID-to-Link mapping) information element in the target wireless frame, wherein the TID-to-Link mapping information element includes first TID-to-Link mapping information of the Non-AP MLD and the AP MLD as well as second TID-to-Link mapping information of the Non-AP MLD and the newly added affiliated AP.

In the embodiments of the present disclosure, it is detected by the obtaining module 501 that the beacon frame sent by the AP MLD includes a newly added affiliated AP, and the obtaining module 501 obtains parameter information of the newly added affiliated AP. The sending module 502 carries the parameter information in a target wireless frame and sends the target wireless frame. The target wireless frame indicates re-establishing a link with the AP MLD. In this way, after the link is re-established, the Non-AP MLD is associated with the newly added affiliated AP, and communicates with the newly added affiliated AP, thus improving the regional throughput.

The present disclosure also provides a communication apparatus. The communication apparatus is applied to a station multi-link device (Non-AP MLD). The apparatus includes:
an information obtaining module to, in a case where a beacon frame sent by an Access Point Multi-Link Device (AP MLD) including a newly added affiliated AP is detected, obtain parameter information of the newly added affiliated AP;
a wireless frame sending module configured to carry the parameter information in a target wireless frame and send the target wireless frame, wherein the target wireless frame indicates re-establishing a link with the AP MLD.

The apparatus also includes other modules of the electronic device in the aforementioned embodiments, which will not be described in detail here.

In an optional embodiment, the embodiment of the present disclosure further provides an electronic device. Referring to FIG. 6, the electronic device 600 shown in FIG. 6 may be a server, including: a processor 601 and a memory 603. The processor 601 and the memory 603 are connected, such as through a bus 602. Optionally, the electronic device 600 may further include a transceiver 604. It should be noted that in actual applications, the electronic device 600 is not limited to have one transceiver 604, and the structure of the electronic device 600 does not constitute a limitation on the embodiments of the present disclosure.

The processor 601 may be a Central Processing Unit (CPU), a general-purpose processor, a Digital Signal Processor (DSP), an Application Specific Integrated Circuit (ASIC), a Field Programmable Gate Array (FPGA) or other programmable logic device, transistor logic device, hardware component or any combination thereof. The processor 601 may implement or execute various example logic blocks, modules and circuits described in conjunction with the disclosure herein. The processor 601 may also be a combination that implements computing functions, such as including a combination of one or more microprocessors, a combination of a DSP and a microprocessor, etc.

The bus 602 may include a path for transmitting information between the above components. The bus 602 may be a Peripheral Component Interconnect (PCI) bus or an Extended Industry Standard Architecture (EISA) bus, etc. The bus 602 may be divided into an address bus, a data bus, a control bus, etc. For ease of representation, FIG. 6 only uses a thick line to represent the bus, but this does not mean that there is only one bus or one type of bus.

The memory 603 may be a Read Only Memory (ROM) or other types of static storage devices that can store static information and instructions, a Random Access Memory (RAM) or other types of dynamic storage devices that can store information and instructions, or an Electrically Erasable Programmable Read Only Memory (EEPROM), a Compact Disc Read Only Memory (CD-ROM) or other optical disk storage, optical disk storage (including compressed optical disk, laser disk, optical disk, digital versatile disk, Blu-ray disk, etc.), a magnetic disk storage medium or other magnetic storage device, or any other medium that can be used to carry or store desired program code(s) in the form of instructions or data structures and can be accessed by a computer, but the present disclosure is not limited to the above examples.

The memory 603 is configured to store application program code(s) for executing the solutions of the present disclosure, and the execution is controlled by the processor 601. The processor 601 is configured to execute the application program code(s) stored in the memory 603 to implement the contents shown in the above method embodiments.

The electronic device includes, but is not limited to, a mobile terminal such as a mobile phone, a laptop computer, a digital broadcast receiver, a Personal Digital Assistant (PDA), a tablet computer (PAD), a Portable Multimedia Player (PMP), a vehicle-mounted terminal (such as a vehicle-mounted navigation terminal), etc., or a fixed terminal such as a digital TV, a desktop computer, etc. The electronic device shown in FIG. 6 is only an example and is not intended to impose any limitation to the functions and scope of use of the embodiments of the present disclosure.

The server provided by the present disclosure may be an independent physical server, or a server cluster or distributed system formed by multiple physical servers, or a cloud server that provides basic cloud computing services such as cloud services, cloud databases, cloud computing, cloud functions, cloud storage, network services, cloud communications, middleware services, domain name services, security services, CDN, and big data and artificial intelligence platforms and so on. The terminal may be a smart phone, a tablet computer, a laptop computer, a desktop computer, a smart speaker, a smart watch, etc., but is not limited thereto. The terminal and the server may be directly or indirectly connected via wired or wireless communication, which is not limited by the present disclosure.

An embodiment of the present disclosure provides a computer-readable storage medium, on which a computer program is stored. When the computer-readable storage medium is run on a computer, the computer can implement the corresponding contents of the aforementioned method embodiments.

It should be understood that, although the steps in the flowcharts of the accompanying drawings are shown in sequence as indicated by the arrows, these steps are not necessarily executed in sequence in the order indicated by the arrows. Unless otherwise specified herein, there is no strict order restriction on the execution of these steps, and the steps can be executed in other orders. Moreover, at least a part of the steps in the flowcharts of the accompanying drawings may include multiple sub-steps or multiple stages, and these sub-steps or sub-stages are not necessarily executed at the same time, but can be executed at different times, and their execution order is not necessarily sequential, but can be executed in turn or alternately with other steps or at least a part of the sub-steps or sub-stages of other steps.

It should be noted that the computer-readable medium mentioned above in the present disclosure may be a computer-readable signal medium or a computer-readable storage medium or any combination of the above two. The computer-readable storage medium may be, for example, but not limited to, an electrical, magnetic, optical, electromagnetic, infrared, or semiconductor system, apparatus or device, or any combination thereof. More specific examples of computer-readable storage medium may include, but are not limited to: an electrical connection with one or more wires, a portable computer magnetic disk, a hard disk, a Random Access Memory (RAM), a Read-Only Memory (ROM), an Erasable Programmable Read-Only Memory (EPROM or flash memory), an optical fiber, a portable Compact Disk Read-Only Memory (CD-ROM), an optical storage device, a magnetic storage device, or any suitable combination of the above. In the present disclosure, the computer-readable storage medium may be any tangible medium containing or storing a program that can be used by or in combination with an instruction execution system, apparatus or device. In the present disclosure, the computer-readable signal medium may include a data signal propagated in a baseband or as part of a carrier wave, which carries computer-readable program code(s). This propagated data signal may take a variety of forms, including but not limited to an electromagnetic signal, an optical signal, or any suitable combination of the above. The computer-readable signal medium may also be any computer readable medium other than computer readable storage medium, and the computer-readable signal medium may send, propagate or transmit a program for use by or in conjunction with an instruction execution system, apparatus or device. The program code(s) contained on the computer-readable medium may be transmitted using any appropriate medium, including but not limited to: a wire, an optical cable, radio frequency (RF), etc., or any suitable combination of the above.

The computer-readable medium may be included in the electronic device, or may exist independently without being incorporated into the electronic device.

The computer-readable medium carries one or more programs. When the one or more programs are executed by the electronic device, the electronic device is caused to implement the methods shown in the above embodiments.

According to an aspect of the present disclosure, a computer program product or a computer program is provided. The computer program product or the computer program includes computer instructions. The computer instructions are stored in a computer-readable storage medium. A processor of a computer device reads the computer instructions from the computer-readable storage medium, and the processor executes the computer instructions, so that the computer device performs the methods provided in the above-mentioned various optional implementations.

Computer program code(s) for performing the operations of the present disclosure may be written in one or more programming languages or a combination thereof, including object-oriented programming languages such as Java, Smalltalk, C++, and conventional procedural programming languages such as “C” or similar programming languages. The program code(s) may be executed entirely on a user's computer, partially on a user's computer, as a separate software package, partially on a user's computer and partially on a remote computer, or entirely on a remote computer or server. In cases involving a remote computer, the remote computer may be connected to a user's computer through any type of network, including a Local Area Network (LAN) or a Wide Area Network (WAN), or may be connected to an external computer (e.g., via the Internet using an Internet service provider).

The flowcharts and block diagrams in the accompanying drawings illustrate the possible architectures, functions and operations of the systems, methods and computer program product according to various embodiments of the present disclosure. In this regard, each block in the flowcharts or block diagram can represent a module, a program segment or a part of a code, and the module, the program segment or the part of the code contains one or more executable instructions for realizing a specified logical function. It should also be noted that in some alternative implementations, the functions marked in the blocks can also occur in a sequence different from that shown in the accompanying drawings. For example, two blocks represented in succession can actually be executed substantially in parallel, or they can sometimes be executed in an opposite order, depending on the functions involved. It should also be noted that each block in the block diagrams and/or flowcharts, and a combination of the blocks in the block diagrams and/or flowcharts can be implemented with a dedicated hardware-based system that performs a specified function or operation, or can be implemented with a combination of dedicated hardware and computer instructions.

The modules involved in the embodiments described in the present disclosure may be implemented by software or hardware. The name of a module does not limit the module itself in some cases. For example, module A may also be described as “module A for performing an operation B”.

The above description only shows example embodiments of the present disclosure and provides an explanation of the technical principles used. Those skilled in the art should understand that the scope of disclosure involved in the present disclosure is not limited to the technical solutions formed by a specific combination of the above technical features, but should also cover other technical solutions formed by any combination of the above technical features or their equivalent features without departing from the above disclosed concept, for example, the above features may be replaced with technical features with similar functions disclosed herein (but not limited to) by each other to form a technical solution.

What is claimed is:

1. A communication method, applied to a station multi-link device (Non-AP MLD), the method comprising:
detecting that a beacon frame sent by an Access Point Multi-Link Device (AP MLD) comprises a newly added affiliated AP, and obtaining parameter information of the newly added affiliated AP; and
carrying the parameter information in a target wireless frame, and sending the target wireless frame, wherein the target wireless frame indicates re-establishing a link with the AP MLD.

2. The communication method according to claim 1, wherein the target wireless frame comprises a reassociation request frame or a reestablishment request frame.

3. The communication method according to claim 1, wherein carrying the parameter information in the target wireless frame comprises:
carrying, in a per-STA profile field in a Basic Multi-Link (Basic ML) information element of the target wireless frame, Link Identity (ID) information corresponding to the newly added affiliated AP and a Station Media Access Control (STA MAC) address of an affiliated STA of the Non-AP MLD under the Link ID.

4. The communication method according to claim 1, further comprising:
carrying a MLD MAC address of the Non-AP MLD in a common information (Common Info) field of a Basic ML information element of the target wireless frame.

5. The communication method according to claim 1, wherein sending the target wireless frame comprises:
sending the target wireless frame in a first link with the newly added affiliated AP, and after receiving a response frame corresponding to the target wireless frame, indicating a STA in a second link with the AP MLD to enter a power saving state; or
sending the target wireless frame in the second link with the AP MLD, and after receiving a response frame corresponding to the target wireless frame, indicating a STA in the first link to enter a power saving state.

6. The communication method according to claim 1, further comprising:
carrying a Traffic Identifier-to-Link mapping (TID-to-Link mapping) information element in the target wireless frame, wherein the TID-to-Link mapping information element comprises first TID-to-Link mapping information of the Non-AP MLD and the AP MLD as well as second TID-to-Link mapping information of the Non-AP MLD and the newly added affiliated AP.

7. An electronic device, wherein the electronic device is a station multi-link device (Non-AP MLD), wherein the electronic device comprises:
an obtaining module configured to detect that a beacon frame sent by an Access Point Multi-Link Device (AP MLD) comprises a newly added affiliated AP, and obtain parameter information of the newly added affiliated AP; and
a sending module configured to carry the parameter information in a target wireless frame, and send the target wireless frame, wherein the target wireless frame indicates re-establishing a link with the AP MLD.

8. A communication apparatus, applied to a station multi-link device (Non-AP MLD), the apparatus comprises:
an information obtaining module to detect that a beacon frame sent by an Access Point Multi-Link Device (AP MLD) comprises a newly added affiliated AP, and obtain parameter information of the newly added affiliated AP; and
a wireless frame sending module configured to carry the parameter information in a target wireless frame, and send the target wireless frame, wherein the target wireless frame indicates re-establishing a link with the AP MLD.

9. An electronic device, comprising a memory, a processor and a computer program stored in the memory and runnable on the processor, wherein when the processor executes the program, the method according to any one of claims 1 to 6 is implemented.

10. A computer-readable storage medium, wherein a computer program is stored on the computer-readable storage medium, and when the computer program is executed by a processor, the method according to any one of claims 1 to 6 is implemented.
